(19) United States
(12) Patent Application Publication
(10) Pub. No.: US 2021/0131827 A1
(43) Pub. Date: May 6, 2021

(54) SHAFT ROTATION ANGLE DETECTION

(71) Applicant: Infineon Technologies AG, Neubiberg (DE)

(72) Inventors: Armin SATZ, Villach (AT); Gernot BINDER, Klagenfurt (AT)

(73) Assignee: Infineon Technologies AG, Neubiberg (DE)

(21) Appl. No.: 17/064,944

(22) Filed: Oct. 7, 2020

(30) Foreign Application Priority Data
Oct. 31, 2019 (DE) 102019216839.6

(51) Int. Cl. G01D 5/14; G01D 5/16

(52) U.S. Cl. CPC G01D 5/145; G01D 5/16

(57) ABSTRACT

An angle sensor for detecting a rotation angle of a shaft, on the axial end of which a permanent magnet is fitted. The permanent magnet has a north pole and a south pole that lie opposite one another across a rotation axis of the shaft. A sensor arrangement includes at least four sensor elements that are arranged with equidistant angles between them on a sensor element circle. The ferromagnetic element is arranged concentrically with a center of the sensor element circle and, when viewed in the direction of the midaxis of the sensor element circle, is point-symmetrical with respect to the center. The angle sensor is arranged relative to the axial end of the shaft such that the rotation axis of the shaft is substantially concentric with the center of the sensor element circle and the sensor arrangement is arranged between the permanent magnet and the ferromagnetic element.

### FIELD

The present disclosure relates to angle sensors and in particular to so-called EOS (End of Shaft) sensors, which are configured to detect the angular position of a rotating shaft. An EOS sensor is a sensor that is arranged facing an end face of a shaft, for example concentrically with an axis of the shaft.

### BACKGROUND

Typical EOS sensors comprise a diametrically magnetized disk magnet or ring magnet, which is fitted on the end of the shaft. An angle sensor, for example a GMR sensor or an AMR sensor, is arranged on the axis, parallel to the surface of the magnet. One problem with such an arrangement may be that the sensors are not robust in relation to leakage fields. In order to achieve the robustness in relation to leakage fields, the sensor may be integrated into the shaft. Such integrated EOS systems comprise an angle sensor that is arranged in the middle of a diametrically magnetized ring magnet. The sensor system is in this case introduced into a cavity of the shaft. The ferromagnetic shaft that encloses the sensor system shields the sensor system against external magnetic leakage fields. Disadvantages are, however, higher costs for the system integration and the magnet design, since a Halbach ring magnet arrangement ought to be used for good behavior.

A differential Hall sensor, which provides intrinsic leakage field robustness, could be used. Four Hall plates are arranged at equidistant angles on a circle. The four Hall plates may be integrated monolithically on a single chip. The circle center is aligned with the axis of the rotating shaft. A disk magnet is fastened on the end of the rotating shaft. Two differential signals, a sine signal and a cosine signal, are obtained while the shaft rotates. The Hall plates may be configured to detect a z component of the magnetic field, i.e. a component in the direction of the axis of the rotating shaft. In order to obtain the differential signals, the output signals of two mutually opposite Hall plates may in each case be subtracted, Bz1−Bz3 and Bz2−Bz4, where Bz1, Bz3, Bz3 and Bz4 correspond to the output signals of the four Hall plates.

### SUMMARY

It would be desirable to have an EOS angle sensor and a method for detecting the rotation angle of a shaft which allow leakage field robustness with reduced outlay.

Examples of the present disclosure provide an angle sensor for detecting a rotation angle of a shaft, on the axial end of which a permanent magnet having at least one north pole and at least one south pole, which lie opposite one another across a rotation axis of the shaft, is fitted. The angle sensor includes a sensor arrangement and a ferromagnetic element. The sensor arrangement includes at least four sensor elements that are arranged with equidistant angles between them on a sensor element circle. The sensor elements are configured to detect magnetic field components perpendicularly to the surface of the sensor element circle. The ferromagnetic element is arranged concentrically with the center of the sensor element circle and, when viewed in the direction of the midaxis, is point-symmetrical with respect to the center. The angle sensor is intended to be arranged relative to the axial end of the shaft in such a way that the rotation axis of the shaft is substantially concentric with the center of the sensor element circle and the sensor arrangement is arranged between the permanent magnet and the ferromagnetic element.

Examples of the present disclosure provide an angle sensor system having such an angle sensor and the permanent magnet, which is fitted on the axial end of the shaft, the angle sensor being fitted relative to the shaft in such a way that the rotation axis of the shaft is substantially concentric with the center of the sensor element circle and the sensor arrangement is arranged between the permanent magnet and the ferromagnetic element.

Examples of the present disclosure provide a method for detecting the rotation angle of a shaft by using such an angle sensor, wherein the angle sensor is fitted relative to a permanent magnet, fitted on a radial end of a shaft, in such a way that the rotation axis of the shaft is substantially concentric with the center of the sensor element circle and the sensor arrangement is arranged between the permanent magnet and the ferromagnetic element. A magnetic field produced by the permanent magnet is detected by means of the at least four sensor elements, and the rotation angle of the shaft is determined by using output signals of the at least four sensor elements.

Examples of the present disclosure therefore allow robust detection in terms of leakage fields of the angle of a rotating shaft with an increased sensitivity, even when Hall sensors, for example Hall plates, are used as sensor elements. In some examples of the disclosure, it is therefore not necessary to use strong rare earth magnets in order to implement an EOS angle sensor that is robust in terms of leakage fields. Besides such leakage field robustness, examples of the disclosure allow a high detection accuracy. Examples of the disclosure allow this by an EOS angle sensor system in which a disk magnet is fitted on the end of a shaft, an angle sensor being arranged between the magnet and the ferromagnetic element, which acts as a magnetic flux concentrator. The angle sensor has intrinsic leakage field robustness because of the use of at least four sensor elements, which are arranged with equidistant angles between them on a sensor element circle.

### BRIEF DESCRIPTION OF THE DRAWINGS

Examples of the disclosure will be described below with reference to the appended drawings, in which:

FIG. 1 shows a schematic representation of an example of an angle sensor, which is arranged on the end of a rotating shaft;

FIG. 2 shows a schematic perspective representation of an example of an EOS angle sensor;

FIG. 3 shows a schematic representation of an example of an arrangement consisting of a magnet, a sensor arrangement and a ferromagnetic element;

FIG. 4 shows a schematic plan view of an example of a sensor arrangement;

FIG. 5 shows a schematic perspective view and a schematic side view of a simulation model;

FIG. 6 shows a diagram that shows exemplary simulated detection signals of a sensor element with and without a pole piece;

FIG. 7 shows exemplary simulated signal amplitudes of a detection element as a function of the pole piece diameter and a distance of the pole piece from a sensor plane;

FIGS. 8, 9, and 10 show exemplary simulated signal amplitudes of a detection element as a function of the pole piece diameter; and

FIG. 11 shows a flowchart of an example of a method according to the present disclosure.

### DETAILED DESCRIPTION

Examples of the present disclosure will be described below in detail and by using the appended descriptions. It should be pointed out that elements which are the same or elements which have the same functionality may be provided with the same or similar references, a repeated description of elements which are provided with the same or similar references typically being omitted. Descriptions of elements which have the same or similar references are mutually interchangeable. In the following description, many details will be described in order to provide a more thorough explanation of examples of the disclosure. For persons skilled in the art, however, it is clear that other examples may be implemented without these specific details. Features of the various examples described may be combined with one another unless features of a corresponding combination exclude one another or such a combination is expressly excluded.

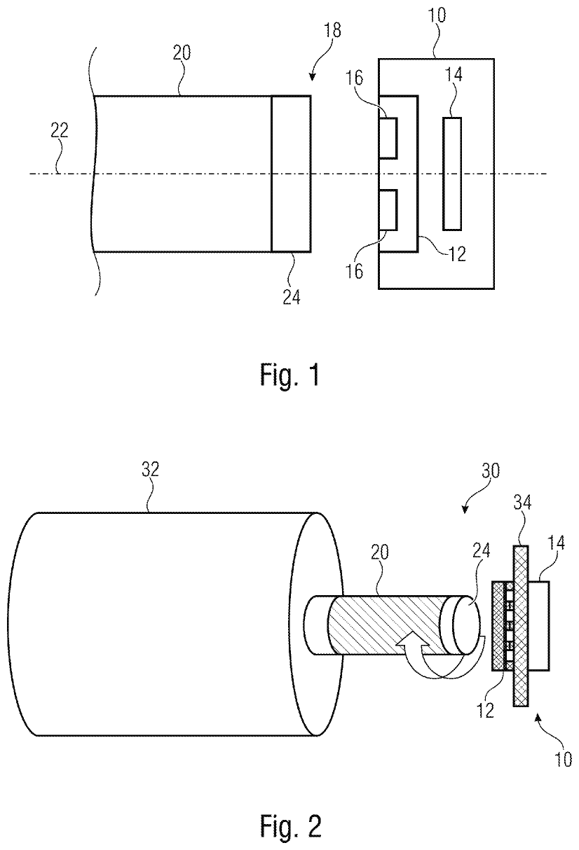

FIG. 1 shows an example of an angle sensor 10, which comprises a sensor arrangement 12 and a ferromagnetic element 14. The sensor arrangement 12 comprises at least four sensor elements 16, which are arranged with equidistant angles between them on a sensor element circle. The sensor arrangement 12 and the ferromagnetic element 14 may be fitted on a common carrier, the ferromagnetic element 14 being arranged concentrically with the center or the midaxis of the sensor element circle. The angle sensor 10 is intended to be arranged relative to an axial end 18 of a shaft 20, the shaft 20 being rotatable about a rotation axis 22. Arranged on the end of the shaft 20, there is a disk magnet 24, which represents a permanent magnet that has a pole pair consisting of a north pole and a south pole, which lie diametrically opposite one another across the rotation axis 22 of the shaft 20. In some examples, the magnet may comprise more than one pole pair, the poles of which respectively lie diametrically opposite. The angle sensor 10 is configured to detect a rotation angle of the shaft 20 by detecting the magnetic field produced by the disk magnet 24. The angle sensor is positioned facing an axial end face, on which the magnet is fitted, of the shaft 20.

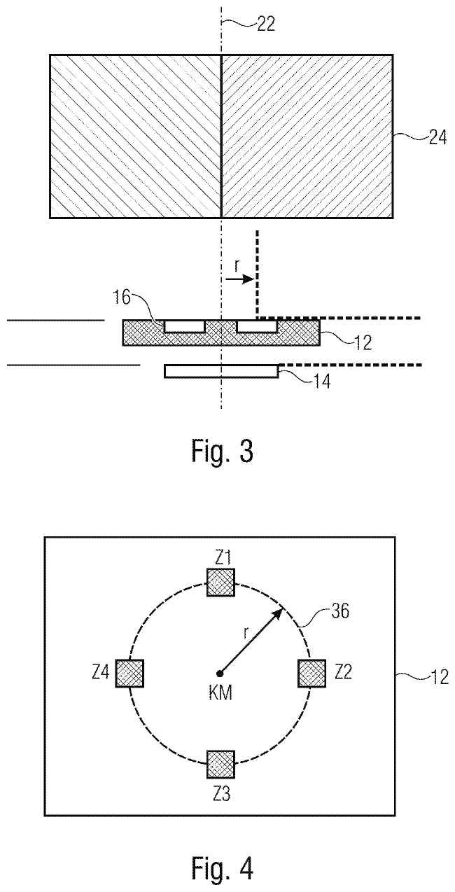

FIG. 2 shows a perspective view of an angle sensor system 30, in which the shaft 20 is the output shaft of an electric motor 32. In the example shown, the sensor arrangement 12 and the ferromagnetic element 14 are fitted on a common carrier 34, which may be a circuit board. In some examples, the angle sensor may comprise a housing, in which case the ferromagnetic element is integrated into the housing or may be fitted externally on the housing. In some examples, the angle sensor comprises a lead frame, the ferromagnetic element being implemented as part of the lead frame. In some examples, the housing comprises an encapsulation material, the ferromagnetic element being formed by ferromagnetic particles in the encapsulation material. In some examples, the ferromagnetic element may therefore be integrated in a compact and simple way into a housing of the angle sensor.

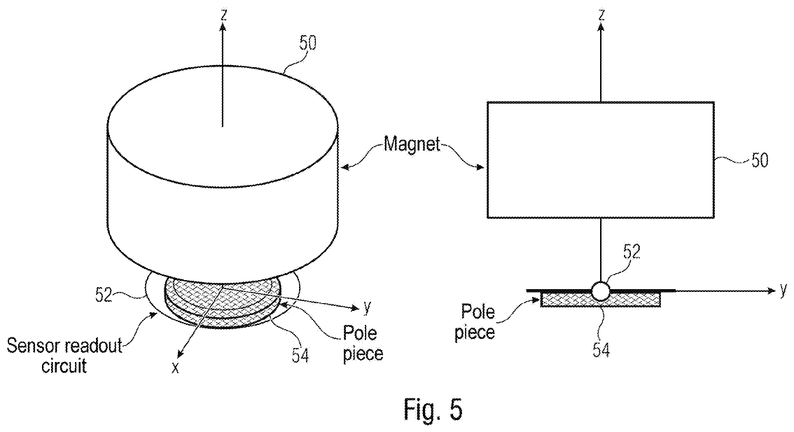

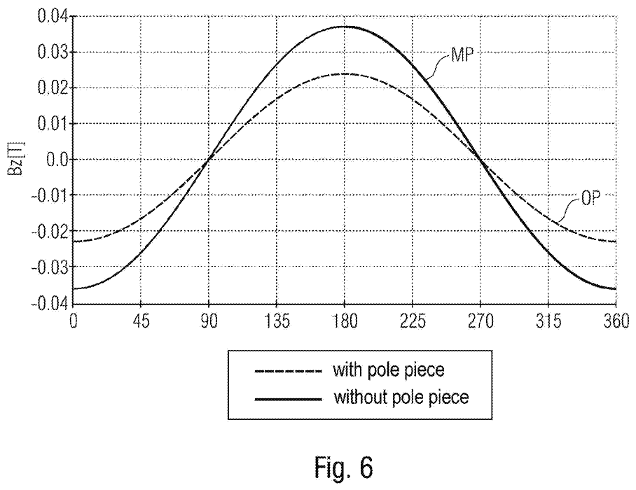

A schematic representation of the arrangement consisting of a disk magnet 24, a sensor arrangement 12 and a ferromagnetic element 14 is shown in FIG. 3. FIG. 4 schematically shows a plan view of the sensor arrangement 12, which comprises four sensor elements that are denoted by Z1, Z2, Z3 and Z4 in FIG. 4. The four sensor elements are arranged on a sensor element circle 36 with an angular spacing of in each case 90° between them. In other examples, a larger number of sensor elements may be provided, differential signals between the output signals of mutually opposite sensor elements respectively being formed. As shown in FIG. 4, the sensor element circle 36 has a radius r from a circle center KM. The radius r, which is also indicated in FIG. 3, may be referred to as a sensor readout radius. The sensor arrangement 12 is arranged between the magnet 24 and the ferromagnetic element 14. The angle sensor 10 is arranged relative to the shaft 20 in such a way that the circle center KM is arranged substantially concentrically with the rotation axis 22. The use of the expression “substantially” is in this case intended to include deviations that lie in a range of up to 10% of the radius r.

The ferromagnetic element 14 acts as a magnetic flux concentrator in order to concentrate the magnetic flux of the magnets toward the sensor elements 16, Z1, Z2, Z3, Z4 of the sensor arrangement 12. To this end, the ferromagnetic element is point-symmetrical with respect to the center of the sensor element circle in plan view, i.e. when looking in the direction of the midaxis of the sensor element circle. Point-symmetrical is in this case intended to mean there is a point reflection that maps this figure onto itself. The point at which this reflection takes place corresponds in plan view to the circle center of the sensor element circle, and may be referred to as a center of symmetry. The midaxis of the sensor element circle extends through the center and is perpendicular to the circle surface of the sensor element circle. In some examples, the ferromagnetic element is rotationally symmetrical when looking in the direction of the midaxis. In some examples, the ferromagnetic element is circular when looking in the direction of the midaxis. In some examples, the ferromagnetic element is cylindrical, spherical, hemispherical or cuboid. In some examples, the magnetic flux may therefore be concentrated uniformly toward the at least four sensor elements of the sensor arrangement.

In some examples of the present disclosure, the shape of the pole piece, which may also be referred to as a flux guiding platelet, is round when looking in the direction of the shaft axis, since in this case the symmetry is best and there are not different effects on the various sensor elements. As an alternative, however, other shapes may also be used so long as concentration of the magnetic flux toward the sensor elements, and therefore amplification of the sensor element output signals, can be induced by them.

In some examples, dimensions of the ferromagnetic element that extend through the midaxis and are perpendicular to the midaxis lie in a range of from 0.9 times to 2 times the diameter of the sensor element circle. In some examples, these dimensions of the ferromagnetic element lie in a range of from 1.2 times to 1.33 times the diameter of the sensor element circle. It has been shown that effective concentration of the magnetic flux toward the sensor elements is possible with such dimensions.

In some examples, the distance between the sensor arrangement and the ferromagnetic element in the direction of the midaxis is less than 550 μm. In this way, it is possible to detect the magnetic field before it has decayed greatly. In some examples, the ferromagnetic element comprises iron, SiFe or NiFe. In some examples, the magnet may consist of such relatively weakly magnetic materials since concentration of the magnetic flux toward the sensor elements is induced by the ferromagnetic element, so that elaborate magnet materials, for example rare earth magnets, are not necessary.

In some examples, the angle sensor comprises a processing circuit that is configured to determine the rotation angle of the shaft by using output signals of the at least four sensor elements. In some examples, the processing circuit is configured to produce a first differential signal by using two diametrically opposite sensor elements of the at least four sensor elements, to produce a second differential signal by using two other diametrically opposite sensor elements of the at least four sensor elements, and to determine the rotation angle on the basis of the arctangent of the quotient of the first and second differential signals. It is therefore possible to detect the rotation angle robustly in terms of leakage fields.

The ferromagnetic element consists of a ferromagnetic material and represents a pole piece, which is provided on a side of the sensor arrangement facing away from the magnet. In a side view, the sensor arrangement is therefore arranged between the magnet and the pole piece. The pole piece may be integrated into an encapsulation housing or fitted on an outer side of the housing. In some examples, a connection lead frame may also consist of a ferromagnetic material and be structured, in order to induce corresponding concentration of the magnetic flux. As mentioned, the pole piece, the sensor element circle, which may also be referred to as a sensor readout circle, and the magnet are aligned concentrically about the rotation axis.

In some examples, the angle sensor, which is an EOS sensor that is robust in terms of leakage fields, comprises four sensor elements that detect the Bz magnetic field component which is generated by the disk magnets. In some examples, these sensor elements are produced as Hall elements, for example lateral Hall plates. In other examples, these sensor elements may be implemented as magnetoresistive elements, for example ones which use anisotropic magnetoresistance (AMR), giant magnetoresistance (GMR) or tunnel magnetoresistance (TMR).

In some examples, the four sensor elements are arranged on a circle with equidistant angles between them, the origin of this sensor readout circle being aligned concentrically with the shaft axis and the magnet cylinder axis. Two differential signals may be obtained from the four sensor elements. The signals are robust in terms of leakage fields. The ferromagnetic pole piece, which may for example consist of iron, SiFe, NiFe or a nickel-iron alloy, for example permalloy, is arranged on the rear side of the sensor arrangement, i.e. on the side thereof facing away from the magnet. The pole piece acts as a flux concentrator and amplifies the magnetic signals that act on the sensor elements. The pole piece may be integrated, for example overmolded, into a housing, or it may be fitted on the rear side of a cast housing. In other examples, a lead frame may consist of a ferromagnetic material or an encapsulation material of the housing itself could contain ferromagnetic particles, in order to form the pole piece.

Examples of the present disclosure therefore provide intrinsic leakage field suppression, the pole piece amplifying output signals of the sensor elements and the signal-to-noise ratio therefore being improved. It is thereby possible to use larger air gaps and to increase the leakage field robustness. It is furthermore possible to use economical weak magnets, for example ferrites.

The magnetic fields which are produced by the disk magnets with an arbitrary air gap AG depend on the angular position of the shaft, which is denoted as θ. The magnetic field components produced in the z direction, i.e. in the direction of the rotation axis, of the four sensor elements Z1, Z2, Z3 and Z4 are:

Z1(AG,θ)=A_{Z}(AG)·sin(θ),

Z2(AG,θ)=A_{Z}(AG)·sin(θ+90°),

Z3(AG,θ)=A_{Z}(AG)·sin(θ+180°),

Z4(AG,θ)=A_{Z}(AG)·sin(θ+270°)

Approximately homogeneous leakage magnetic field components Zs are assumed. This assumption makes it possible to describe the output signals of the four magnetic field sensor elements as a function of the angular position θ of the shaft as follows:

Z1(θ)=S_{Z}·(A_{Z}·sin(θ)+Zs),

Z2(θ)=S_{Z}·(A_{Z}·sin(θ+90°)+Zs),

Z3(θ)=S_{Z}·(A_{Z}·sin(θ+180°)+Zs),

Z4(θ)=S_{Z}·(A_{Z}·sin(θ+270°)+Zs).

In this case, equal sensitivities Sz of the four magnetic field sensor elements and vanishing residual offsets for all four magnetic field sensor elements are assumed. Methods to compensate for deviations from these assumptions are known, for example offset elimination by using so-called spinning and chopping methods, and calibration of sensor amplitudes and of nonorthogonalities. In some examples, such methods may be used to compensate for deviations.

Because of the equal air gap and the equal radial distance of the four magnetic field sensor elements from the shaft axis, the Z amplitudes of the four magnetic field sensor elements have substantially the same magnitude.

The sensor signals of in each case two opposite sensor elements of the magnetic field sensor elements may be subtracted in order to obtain differential signals that are robust in terms of leakage fields:

ΔZ1(θ)=Z1(θ)−Z3(θ)=S_{Z}·(2*Az)·cos(θ),

ΔZ2(θ)=Z2(θ)−Z4(θ)=S_{Z}·(2*Az)·sin(θ)

These differential signals that are robust in terms of leakage fields have the same amplitude and are phase-shifted by 90°. Calculation of the arctangent of these differential signals gives the angular position θ of the shaft:

$$θ = atan ( \frac{Δ Z 2 ( θ )}{Δ Z 1 ( θ )} )$$

The angular position θ of the shaft may therefore be determined from the four output signals of the sensor elements. In order to increase the magnetic signal amplitudes Az, the ferromagnetic element, or pole piece, is added to the sensor system. In this case, the sensor arrangement is arranged between the magnet and the pole piece. In some examples, a cylindrical pole piece in the form of a disk is used. In other examples, the pole piece may also be cuboid or have a so-called ashlar shape. In other examples, the pole piece may have an elliptical shape, a spherical shape or a hemispherical shape. As described, in some examples a magnet platelet, a center of the sensor readout circle and the pole piece are aligned concentrically with the shaft axis, i.e. the center of rotation.

Examples of the present disclosure may, in particular, be used for exact angle measurement, for example rotor position detection for brushless electric motors. An increase in the electrification, for example in motor vehicle applications with a 48 V vehicle electrical system and electrification of the transmission, may produce additional magnetic leakage fields. Examples of the present disclosure allow reliable detection of the rotation angle even in such applications.

Examples of the present disclosure therefore provide an EOS sensor system that is robust in terms of leakage fields, which comprises a permanent magnet, a magnetic field sensor and a ferromagnetic element, which is also referred to here as a pole piece. The magnetic field sensor may be configured as a magnetic field sensor chip that comprises four sensor elements, sensitive in the z direction, which are arranged at equidistant angles on a circle having the sensor readout radius r. Two differential signals that are robust in terms of leakage fields are obtained, Z1−Z3 (sine signal) and Z2−Z4 (cosine signal). By using the trigonometric arctangent function, it is possible to determine the shaft angle. The ferromagnetic pole piece increases the magnetic signals at the sensor elements. The pole piece is arranged on the side of the sensor arrangement facing away from the magnet. In a side view, the sensor arrangement is therefore arranged between the magnet and the pole piece. The magnet, the sensor arrangement, i.e. the middle of the sensor readout circle, and the pole piece are aligned concentrically with the shaft axis. It has been found that the magnetic signal amplitudes may be effectively amplified, or maximized, when dimensions of the pole piece in plan view lie in a range of from 0.9 to 2 times the sensor readout circle diameter (2× readout radius r). In some examples, in the case of a cylindrical, spherical or hemispherical pole piece, the diameter lies in a range of from 0.9 to 2 times the sensor readout circle diameter.

In some examples, a distance of the pole piece from the sensitive region, i.e. the sensor arrangement, in the direction of the shaft axis may lie in a range of less than 550 μm, for example in a range of from 300 to 400 μm, for example at 350 μm. It has been shown that in such a case, a pole piece diameter in a range of from 1.2 to 1.33 times the sensor readout circle diameter is optimal in respect of the flux concentration toward the sensor elements. It has been shown that, by using a pole piece having dimensions perpendicular to the shaft axis that lie in the range described, signal amplification in a range of a factor of between 2.5 and 4 may be achieved. Examples of the present disclosure therefore allow the use of weak, economical magnets, for example ferrites, an increase in the signal/noise ratio, an increased usable air gap range, and/or an increased leakage field robustness.

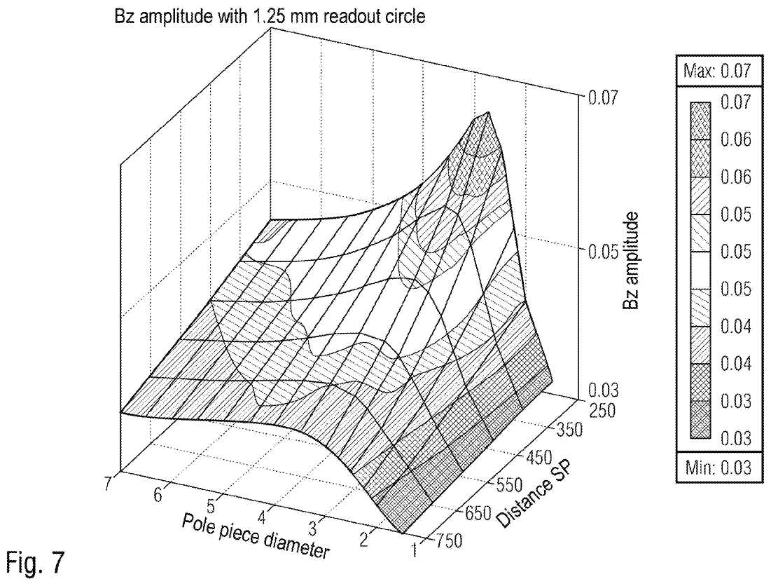

Simulations which confirm the described effects were carried out. FIG. 5 shows a simulation model having a cylindrical, diametrically magnetized neodymium magnet having a diameter of 6 mm and a height of 3 mm. More precisely, plastic-bonded isotropic NdFeB having a remanence Br=0.51 T and a coercivity field strength HcB=−355 kA/m was used as a material of the magnet for the simulation. 52 schematically shows a sensor readout circle, which comprises four sensor elements, different sensor readout circle diameters of 1.5 mm, 2.0 mm and 2.5 mm having been used. The simulations were carried out with a typical air gap AG of 2.0 mm, the air gap AG corresponding to the distance between the magnet and the sensitive plane, i.e. the plane in which the sensor elements are arranged. A cylindrical pole piece having a height of 0.3 mm was arranged on the side of the sensor readout circle facing away from the magnet. As may be seen from the simulation model in FIG. 4, the magnet 50, the sensor readout circle 52 and the pole piece 54 are aligned coaxially with the rotation axis, which in FIG. 5 coincides with the z axis. The diameter of the pole piece and the distance of the pole piece from the sensitive plane were varied in the model, i.e. during the simulation.

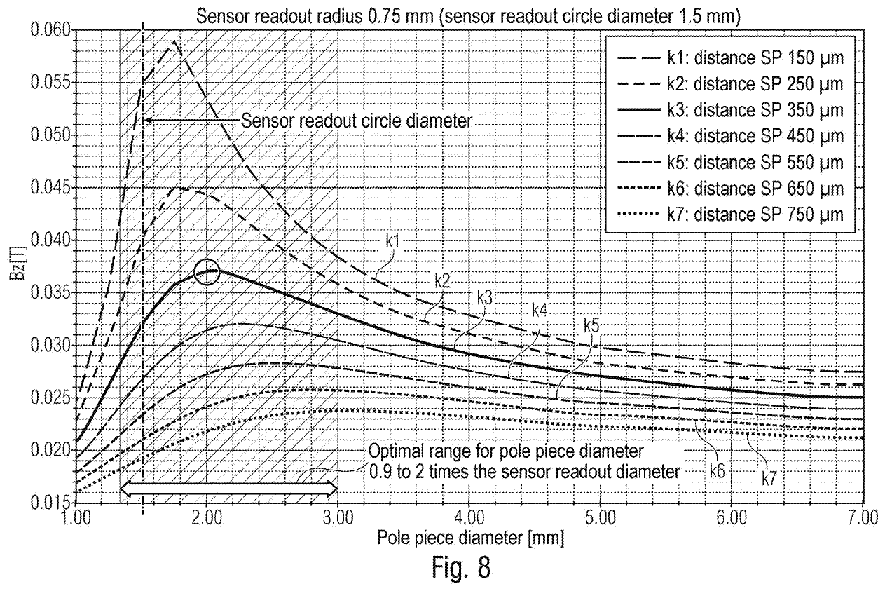

In a first simulation, a sensor having a sensor readout circle diameter of 2.5 mm was used. The pole piece dimension was set to a diameter of 6 mm and a height of 0.3 mm, a distance from the sensitive plane being 700 μm. FIG. 6 shows the result of this simulation on the one hand without a pole piece, curve OP, and on the other hand with an iron pole piece having a magnetic permeability μr=4000, curve MP. As may be seen in FIG. 6, Bz signals that reflect the magnetic field component in the z direction are amplified by the pole piece by a factor of 1.6. FIG. 6 in this case shows the respective Bz signals over a full revolution of 360°.

In order to improve and further optimize this amplification factor, additional simulations were carried out with a different geometry. In particular, the thickness and the diameter of the pole piece were varied, as well as the distance of the pole piece from the sensitive plane, i.e. the sensor arrangement. The sensitive plane may in this case be regarded as the plane that extends perpendicularly to the shaft axis through the middles of the respective sensor elements.

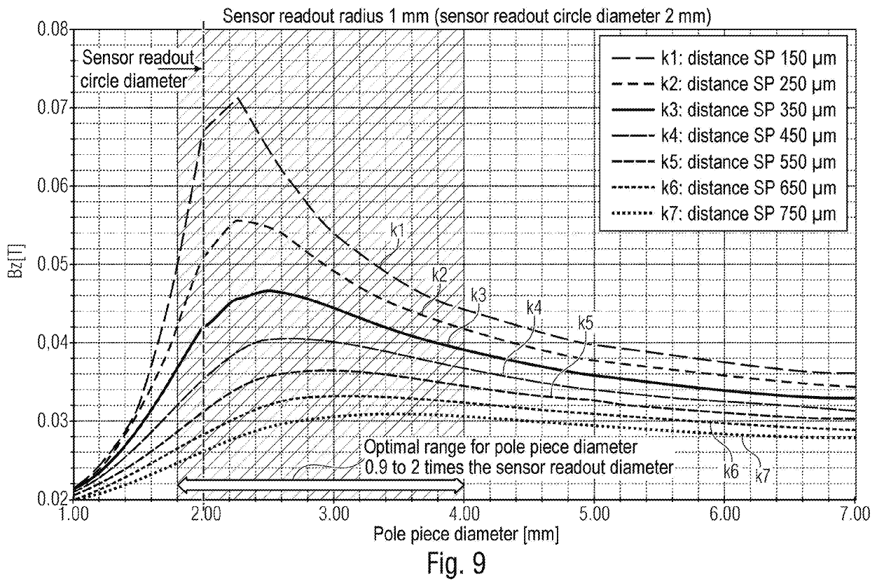

FIG. 7 shows the Bz signal amplitude for a sensor having a sensor readout circle radius of 1.25 mm as a function of the pole piece diameter and the distance SP of the pole piece from the sensor arrangement in the z direction. The smaller the distance of the pole piece from the sensor plane is, the higher the signal amplitude is. As may be seen in FIG. 7, the amplitude reaches its maximum when the pole piece diameter is in the range of the sensor readout circle diameter or slightly greater. In the example shown, this is slightly more than 2.5 mm.

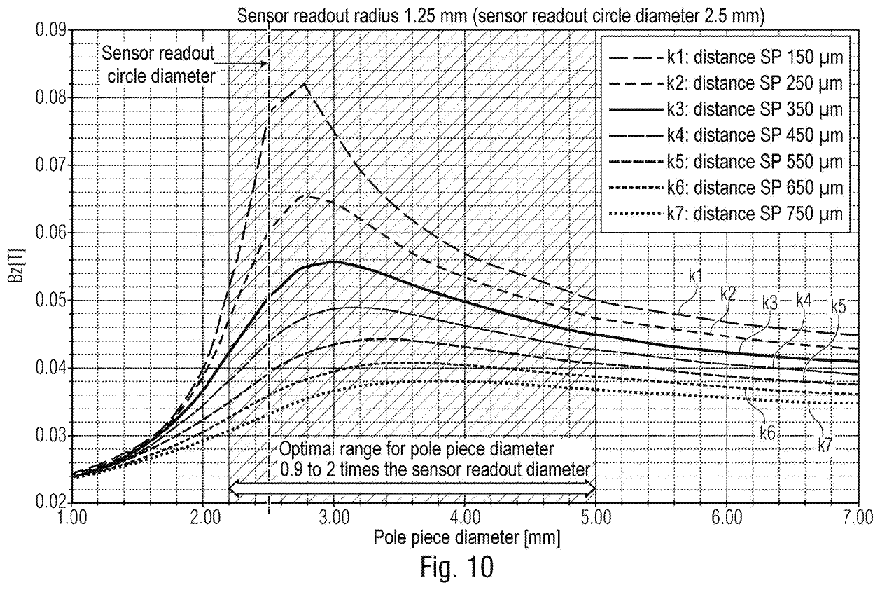

Furthermore, simulations were carried out for different sensor readout circle radii and the results were evaluated. The corresponding results are represented in FIGS. 8 to 10. FIG. 8 shows the results for a sensor readout circle diameter of 1.5 mm, FIG. 9 shows the results for a sensor readout circle diameter of 2 mm and FIG. 10 shows the results for a sensor readout circle diameter of 2.5 mm. FIG. 10 in this case shows the same results as FIG. 7 in a different type of representation. In each of FIGS. 8 to 10, the distance SP between the sensor plane and the pole piece was respectively varied between 150 μm and 750 μm, the respective results being represented as curves k1 to k7. In FIGS. 8 to 10, each curve k1 to k7 represents a different z distance, the signal reaching its maximum at a low z distance.

Furthermore, FIGS. 8 to 10 respectively indicate an optimal range for the pole piece diameter by a double-headed arrow. The simulation results therefore show that a pole piece diameter in a range of 0.9 to 2.0 times the sensor readout circle diameter is most effective. For smaller z distances SP, the factor should be closer to 0.9, while it should be closer to the factor 2 for larger z distances SP.

Considering for example curve k3 in FIG. 8, which is associated with a distance SP of 350 μm, the ideal pole piece diameter would in this case be 2 mm, which corresponds to the sensor readout circle diameter multiplied by a factor of 1.33. Considering for example curve k3 in FIG. 9, the ideal pole piece diameter would in this case be 2.5 mm, which corresponds to the sensor readout circle diameter multiplied by a factor of 1.25. Considering for example curve k3 in FIG. 10, the ideal pole piece diameter would in this case be 3 mm, which corresponds to the sensor readout circle diameter multiplied by a factor of 1.20. It is therefore shown that for larger readout circle diameters, the factor should be smaller in relative terms than for smaller readout circle diameters.

In some examples of the present disclosure, a pole piece diameter is therefore selected as a function of the sensor readout circle diameter, a factor by which the sensor readout circle diameter is multiplied in order to obtain the pole piece diameter being greater when the sensor readout circle diameter is smaller, and smaller when the sensor readout circle diameter is greater.

The simulations show, for example, that with a readout circle diameter of 2.5 mm and a pole piece with a diameter of 3 mm, which is arranged for example at a distance of 350 μm from the sensor in a housing, a signal amplification of 250% may be obtained. If the pole piece is correspondingly integrated into a sensor housing having a smaller distance from the sensor arrangement, even higher amplifications of up to 400% are possible.

It should be pointed out that the dimensions and distances specified above are exemplary, and that different dimensions and distances may be used in other implementations.

Examples of the present disclosure therefore provide a sensor arrangement in which a cylindrical pole piece is provided on a side of a sensor arrangement facing away from a magnet, the end faces of the cylinder being arranged perpendicularly to the midaxis of the sensor readout circle and therefore perpendicularly to the rotation axis of the shaft. The end faces of the pole piece and the circular surface of the sensor element circle may be arranged parallel to one another. The diameter of the cylinder is selected as a function of the diameter of the sensor readout circle, in some examples the pole piece diameter being selected in a range of from 1.2 times to 1.33 times the diameter of the sensor readout circle.

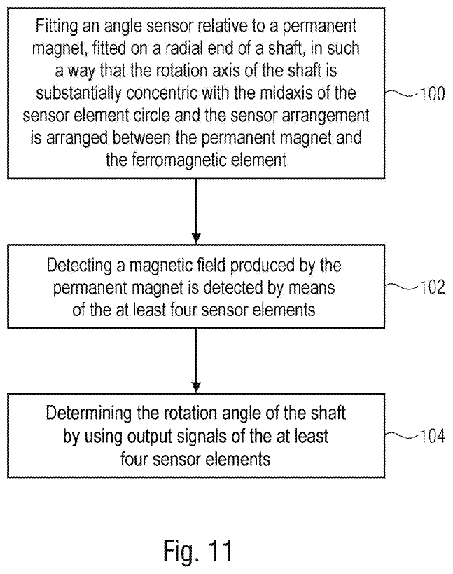

Examples provide a method as shown in FIG. 11. At 100, an angle sensor as described here is fitted relative to a permanent magnet, fitted on a radial end of a shaft, in such a way that the rotation axis of the shaft is substantially concentric with the midaxis of the sensor element circle and the sensor arrangement is arranged between the permanent magnet and the ferromagnetic element. At 102, a magnetic field produced by the permanent magnet is detected by means of the at least four sensor elements. In some examples, in this case the magnetic field component in the direction of the rotation axis of the shaft is respectively detected. At 104, the rotation angle of the shaft is then determined by using output signals of the at least four sensor elements.

In some examples, the processing circuit may be implemented by any desired suitable circuit structures, for example microprocessor circuits, ASIC circuits, CMOS circuits and the like. In some examples, the processing circuit may be implemented as a combination of hardware structures and machine-readable instructions. For example, the processing circuit may comprise a processor and memory devices that store machine-readable instructions which lead to the method described here being carried out when they are executed by the processor.

Although some aspects of the present disclosure have been described as features in connection with a device, it is clear that such a description may likewise be regarded as a description of corresponding method features. Although some aspects have been described as features in connection with a method, it is clear that such a description may likewise be regarded as a description of corresponding features of a device or of a functionality of the device.

In the detailed description above, various features have sometimes been grouped together in examples in order to rationalize the disclosure. This type of disclosure is not meant to be interpreted as the intention that the examples claimed comprise more features than are expressly specified in each claim. Rather, as reflected in the following claims, the subject-matter may reside in fewer than all features of an individual disclosed example. Consequently, the following claims are hereby incorporated into the detailed description, and each claim may stand as its own separate example. While each claim may stand as its own separate example, it should be mentioned that although dependent claims in the claims refer back to a specific combination with one or more other claims, other examples also comprise a combination of dependent claims with the subject-matter of any other dependent claim or a combination of each feature with other dependent or independent claims. Such combinations are to be included unless it is mentioned that a specific combination is not intended. It is furthermore intended that a combination of features of a claim with any other independent claim is also included, even if this claim is not directly dependent on the independent claim.

The examples described above are only representative of the fundamentals of the present disclosure. It is to be understood that modifications and variations of the arrangements and of the details that are described are clear to persons skilled in the art. It is therefore intended that the disclosure is limited only by the appended patent claims and not by the specific details that are presented for the purpose of description and explanation of the examples.

### LIST OF REFERENCES

10 angle sensor
12 sensor arrangement
14 ferromagnetic element, pole piece
16 sensor elements
18 axial shaft end
20 shaft
22 rotation axis
24 magnet
30 angle sensor system
32 electric motor
34 common carrier
36 sensor element circle, sensor readout circle
Z1, Z2, Z3, Z4 sensor elements
KM circle center
50 magnet
52 sensor readout circle
54 pole piece

What is claimed is:

1. An angle sensor for detecting a rotation angle of a shaft, on the axial end of which a permanent magnet is fitted, the permanent magnet having at least one north pole and at least one south pole, which lie opposite one another across a rotation axis of the shaft, the angle sensor comprises:
a sensor arrangement comprising at least four sensor elements that are arranged with equidistant angles between them on a sensor element circle, the at least four sensor elements being configured to detect magnetic field components perpendicularly to a surface of the sensor element circle; and
a ferromagnetic element that is arranged concentrically with a circle center of the sensor element circle and, when viewed in a direction of a midaxis of the sensor element circle, is point-symmetrical with respect to the circle center of the sensor element circle,
wherein the angle sensor is arranged relative to the axial end of the shaft in such a way that the rotation axis of the shaft is substantially concentric with the circle center of the sensor element circle and the sensor arrangement is arranged between the permanent magnet and the ferromagnetic element.

2. The angle sensor as claimed in claim 1, wherein the ferromagnetic element is rotationally symmetrical when viewed in the direction of the midaxis of the sensor element circle.

3. The angle sensor as claimed in claim 2, wherein the ferromagnetic element is circular when viewed in the direction of the midaxis of the sensor element circle.

4. The angle sensor as claimed in claim 1, wherein the ferromagnetic element is cylindrical, spherical, hemispherical, or cuboid.

5. The angle sensor as claimed in claim 1, further comprising:
a housing, the ferromagnetic element being integrated into the housing or being fitted externally on the housing.

6. The angle sensor as claimed in claim 5, further comprising:
a lead frame, wherein the ferromagnetic element is implemented as part of the lead frame.

7. The angle sensor as claimed in claim 5, wherein the housing comprises an encapsulation material, and the ferromagnetic element is formed by ferromagnetic particles in the encapsulation material.

8. The angle sensor as claimed in claim 1, wherein dimensions of the ferromagnetic element that extend through the midaxis of the sensor element circle and are perpendicular to the midaxis lie in a range of from 0.9 times to 2 times a diameter of the sensor element circle.

9. The angle sensor as claimed in claim 8, wherein the dimensions of the ferromagnetic element that extend through the midaxis of the sensor element circle and are perpendicular to the midaxis are in a range of from 1.2 times to 1.33 times the diameter of the sensor element circle.

10. The angle sensor as claimed in claim 1, wherein a distance between the sensor arrangement and the ferromagnetic element in the direction of the midaxis of the sensor element circle is less than 550 μm.

11. The angle sensor as claimed in claim 1, wherein the ferromagnetic element comprises iron, SiFe, NiFe, or an iron/nickel alloy.

12. The angle sensor as claimed in claim 1, further comprising:
a processing circuit that is configured to determine the rotation angle of the shaft by using output signals of the at least four sensor elements.

13. The angle sensor as claimed in claim 12, wherein the processing circuit is configured to produce a first differential signal by using two diametrically opposite sensor elements of the at least four sensor elements, to produce a second differential signal by using two other diametrically opposite sensor elements of the at least four sensor elements, and to determine the rotation angle on the basis of the arctangent of the quotient of the first and the second differential signals.

14. An angle sensor system, comprising:
an angle sensor for detecting a rotation angle of a shaft, the angle sensor comprising:
a sensor arrangement comprising at least four sensor elements that are arranged with equidistant angles between them on a sensor element circle, the at least four sensor elements being configured to detect magnetic field components perpendicularly to a surface of the sensor element circle; and
a ferromagnetic element that is arranged concentrically with a circle center of the sensor element circle and, when viewed in a direction of a midaxis of the sensor element circle, is point-symmetrical with respect to the circle center of the sensor element circle; and
a permanent magnet fitted on the axial end of the shaft, the permanent magnet having at least one north pole and at least one south pole, which lie opposite one another across a rotation axis of the shaft,
wherein the angle sensor is fitted relative to the shaft in such a way that the rotation axis of the shaft is substantially concentric with the center of the sensor element circle and the sensor arrangement is arranged between the permanent magnet and the ferromagnetic element.

15. The angle sensor system as claimed in claim 14, wherein the permanent magnet is a diametrically magnetized cylindrical permanent magnet that is fastened concentrically on the axial end of the shaft.

16. The angle sensor system as claimed in claim 14, wherein the permanent magnet consists of a ferrite material.

17. A method for detecting the rotation angle of a shaft, the method comprising:
fitting an angle sensor relative to a permanent magnet that is fitted on a radial end of a shaft, the angle sensor being arranged in such a way that the rotation axis of the shaft is substantially concentric with a center of a sensor element circle defined by at least four sensor elements that are arranged with equidistant angles between them on the sensor element circle, and the sensor arrangement is arranged between the permanent magnet and the ferromagnetic element;
detecting a magnetic field produced by the permanent magnet by means of the at least four sensor elements; and
determining the rotation angle of the shaft by using output signals of the at least four sensor elements.

18. The method as claimed in claim 17, wherein the determination of the rotation angle comprises:
producing a first differential signal by using two diametrically opposite sensor elements of the at least four sensor elements;
producing a second differential signal by using two other diametrically opposite sensor elements of the at least four sensor elements; and
determining the rotation angle by calculating the arctangent of the quotient of the first and the second differential signals.
